(19) United States
(12) Patent Application Publication
(10) Pub. No.: US 2007/0121812 A1
(43) Pub. Date: May 31, 2007

(54) System and method for lawful intercept detection of call data and call content

(75) Inventors: Michael S. Strange, Rowlett, TX (US); Wen-Yang Chang, Plano, TX (US); Michael D. McKinley, Garland, TX (US)

Correspondence Address: DOCKET CLERK, P.O. DRAWER 800889, DALLAS, TX, 75380, US

(73) Assignee: SAMSUNG ELECTRONICS Co., LTD., Suwon-city (KR)

(21) Appl. No.: 11/284,788

(22) Filed: Nov. 22, 2005

(51) Int. Cl. H04M 1/64

(52) U.S. Cl. 379/70

(57) ABSTRACT

A telecommunications switch receives a lawful intercept message identifying a target device and updates a subscriber database according to the message. Upon an origination of a call associated with the target device, the switch enables a lawful intercept detection point associated with the call. When the detection point occurs, the switch transmits a message indicating the occurrence of the detection point. The switch may include a service control point co-located with the switch. The lawful intercept message may be received from, and the message indicating the occurrence of the lawful intercept detection point may be transmitted to, a lawful intercept delivery function. Upon an origination of a call associated with the target device, the switch may also cause a media gateway to transmit call content from the call to the lawful intercept delivery function.

### TECHNICAL FIELD OF THE INVENTION

The present disclosure is directed in general to telecommunication switches and, more specifically, to a method and system for lawful intercept detection of call data and call content in a telecommunication switch.

### BACKGROUND OF THE INVENTION

Modern telecommunication switches support both voice services and data services. Among other things, such switches direct the switching activities of media gateways, which are used to convert voice and control signals from analog format (e.g., PSTN, SS7, etc.) to IP packets. A switch (such as a Softswitch) may handle calls from media gateways using a number of telecommunication protocols, such as ISUP (Signaling System No. 7 ISDN User Part), SIP (Session Initiation Protocol), H.323 (International Telecommunication Union H.323 Standard), and POTS (Plain Old Telephone Service). The devices communicating through a switch may include wireless phones, landline phones, pagers, facsimile machines, and computing devices. Although telecommunication switches perform different levels of call processing, their functionality generally relates to call control and routing, signaling intelligence, service creation and enhanced Intelligent Network services such as 800-number translations.

Under the Communications Assistance for Law Enforcement Act (CALEA) passed by Congress in 1994, telecommunication providers are required to provide both call-identifying information and call content to court authorized law enforcement agencies for call intercept target telephones. Call-identifying information includes the phone numbers of calling devices that call the intercept target and called devices that are called by the intercept target. Other information may be required as well: the duration of calls to or from the target; additional digits dialed during a call; the use of features such as conference calling, call forwarding, and call waiting; and signals sent by the provider to an intercept target, such as message-waiting tones, special dial tones, and busy signals.

Therefore, there is a need in the art for delivery of lawfully intercepted call data and call content. In particular, there is a need for a telecommunications switch capable of lawful intercept detection of call data and call content.

### SUMMARY OF THE INVENTION

In one embodiment, a telecommunications network switch is provided that includes a call control function, a lawful intercept server, and one of an access control function and a service control point and a subscriber database. Upon receiving a lawful intercept message identifying a target device, the lawful intercept server causes the call control function to update a subscriber database and the switch awaits the origination of a call associated with the target device. When such a call occurs, the call control function causes the access control function and/or service control point to enable a lawful intercept detection point associated with the call. When such a detection point occurs, the lawful intercept server transmits a message indicating the occurrence of the detection point.

In another embodiment, a method is provided for lawful interception of call data and call content in a telecommunications network that includes the steps of receiving a lawful intercept message identifying a target device and updating a subscriber database according to the message. The method also includes the step of enabling a lawful intercept detection point upon a subsequent origination of a call associated with the target device. The method further includes, upon an occurrence of the enabled detection point, the step of transmitting a message indicating the occurrence.

In still another embodiment, logic is provided for use in a switch of a telecommunications network, where the logic is operable to receive a lawful intercept message identifying a target device and update a subscriber database according to the message. The logic is also operable to enable a lawful intercept detection point upon a subsequent origination of a call associated with the target device. The logic is further operable, upon an occurrence of the enabled detection point, to transmit a message indicating the occurrence.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a system for providing lawful interception of call data and call content according to one embodiment of the present disclosure;

FIG. 2 shows an exemplary telecommunications switch according to one embodiment of the present disclosure; and

FIG. 3 is a flow chart of call data and call content interception in a telecommunications switch according to one embodiment of the present disclosure.

### DETAILED DESCRIPTION OF THE INVENTION

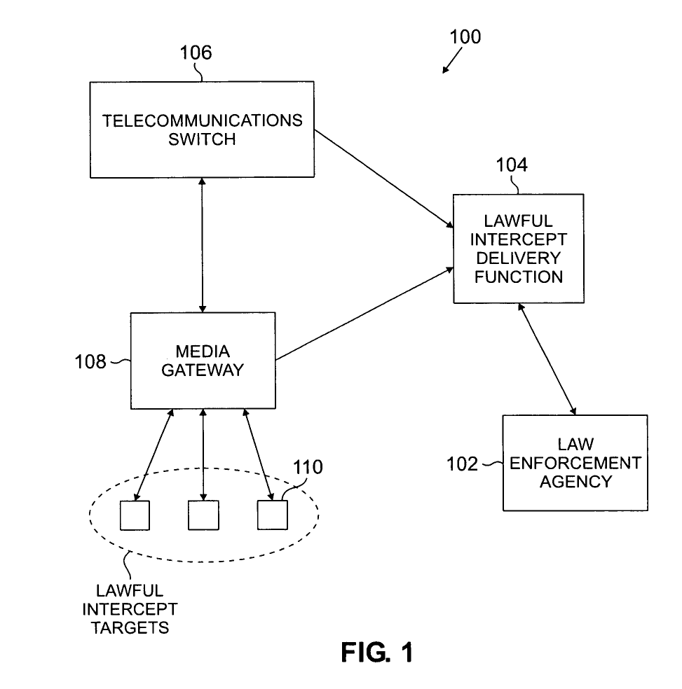

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication network.

The present disclosure describes a telecommunications network switch that contains a lawful intercept server that provides lawful interception of call data and call content. Upon receiving a lawful intercept message identifying a target device, the lawful intercept server causes a call control function to update a subscriber database and the switch awaits the origination of a call associated with the target device, for example a call to or from the target device. As used herein, a target device may include any type of telephony device, including but not limited to, a wireless phone, a landline phone, a pager, a facsimile machine, a computer or a similar processing system, among others. Moreover, in an exemplary embodiment of the present disclosure, the lawful intercept server may be embodied as logic (i.e., software application program) stored on a storage device (i.e., CD-ROM) that may be installed in a Softswitch or a similar switching device.

FIG. 1 illustrates a telecommunications system 100 for providing lawful interception of call data and call content according to the principles of the present disclosure. In the exemplary system 100, a law enforcement agency (LEA) 102 may use lawful intercept delivery function (LIDF) 104 to capture and convert call data and/or call content into a required legal intercept standard format. When the LEA 102 receives court authorization to intercept a particular lawful intercept target device 110, the LEA 102 signals the LIDF 104 to begin intercepting the target device 110. This signal includes information identifying the target device 110 to be intercepted and the type of surveillance authorized.

The LIDF 104, in turn, sends a lawful intercept message to a telecommunications switch 106 coupled to a media gateway 108 that serves the identified lawful intercept target device 110. In response to receipt of the lawful intercept message, the switch 106 records the identity of the target device 110 and the type of surveillance authorized, and begins monitoring call traffic for a call associated with the target device 110. When the switch 106 detects such a call, it begins intercepting call data regarding the call and transmitting the call data to the LIDF 104. If authorized, the switch also signals the media gateway 108 to begin intercepting call content and to transmit the intercepted call content to the LIDF 104.

When the switch 106 detects the termination of the call to the intercept target device 110, the switch 106 transmits the call termination data to the LIDF 104. At that point, if appropriate, the switch 106 also signals the media gateway 108 to cease transmitting intercepted call content to the LIDF 104. The switch 106 then resumes monitoring call traffic for another call associated with the target device 110.

Call data and call content collected by the LIDF 104 are subsequently sent to the LEA 102 requesting the intercept. When the type of surveillance authorized is changed or the intercept authorization expires, the LIDF 104 sends a message reflecting that change or expiration to the telecommunications switch 106, which modifies or deletes its internal information accordingly.

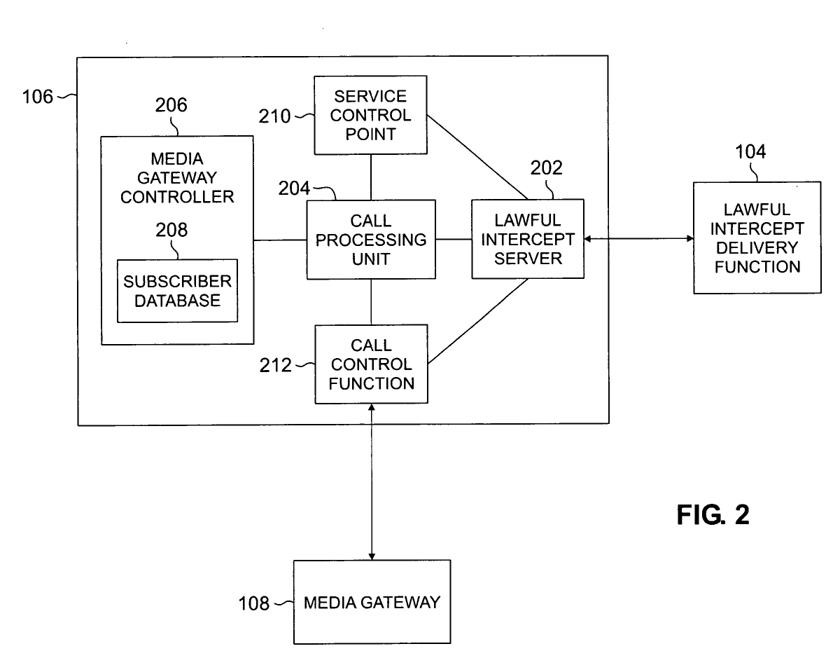

FIG. 2 shows exemplary telecommunications switch 106 in greater detail according to one embodiment of the present disclosure. A lawful intercept server (LIS) 202 provides an interface between switch 106 and LIDF 104. The LIS 202 receives a lawful intercept message from LIDF 104, identifying a lawful intercept target 110 served by switch 106 and the type of surveillance authorized. Upon receipt of such a message, the LIS notifies a call control function 204 that the identified target device 110 is the target of a lawful intercept. The call control function 204, in turn, updates a subscriber database 208 containing the subscriber record associated with the identified target device 110 to reflect the intercept status of the target device 110.

The call control function (CCF) 204 then begins monitoring call traffic to detect calls associated with the target device 110. When such a call is detected, the CCF 204, in accordance with the intercept status of the target device 110 in the subscriber database 208, causes a service control point (SCP) 210 and an access control function (ACF) 212 to enable lawful intercept detection points (LIDPs) related to the call. If authorized, the CCF 204 may also signal the media gateway 108 to begin intercepting call content and to transmit the intercepted call content to the LIDF 104.

A detection point is a point in basic call processing at which an event may be reported and transfer of processing may take place. An LIDP is a detection point that marks the occurrence of a call processing event to be recorded by the LIDF 104.

The SCP 210 may detect LIDPs such as Answer (indicating a call to or from the target device 110 has been answered), Origination (indicating that the target device 110 is originating a call), Release (indicating the release of resources used for a call being intercepted), and TerminationAttempt (indicating the detection of a call to the target device 110). When the SCP 210 detects an LIDP, it will send a message to the LIS 202 indicating the LIDP that has been detected. The LIS 202 then transmits a message to the LIDF 104 indicating the occurrence of the lawful intercept detection point detected by the SCP 210.

Similarly, the ACF 212 may detect LIDPs that will result in messages such as CCOpen (indicating the initiation of call content delivery), CCClose (indicating the end of call content delivery), and NetworkSignal (indicating the sending of an audible signal to the target device 110) being sent to the LIDF 104. Upon an origination or termination attempt, the ACF 212 causes the LIS 202 to transmit a CCOpen message to the LIDF 104. When the ACF 212 releases an intercept target, it causes the LIS 202 to transmit a CCClose message to the LIDF 104. Similarly, when the ACF 212 sends a supervision message to the media gateway 108 to play a tone or announcement, the ACF 212 causes the LIS 202 to transmit a NetworkSignal message to the LIDF 104.

In some embodiments, the SCP 210 may be an external device to the telecommunications switch 106. In such a system, messages from the SCP 210 to the LIS 202 may be encoded in the Abstract Syntax Notation One (ASN.1) format. Similarly, the LIDF 104, as an external device, may also use the ASN.1 format. However, if needed, the LIS 202 may convert messages from the SCP 210 into a format understood by the LIDF 104.

In an advantageous embodiment, the SCP 210 may be co-located with the switch 106, as shown in FIG. 2. In this way, communications overhead between the SCP 210 and the LIS 202 may be minimized. Furthermore, when the SCP 210 and the ACF 212 are co-located with the LIS 202 in the switch 106, messages between the SCP 210, the ACF 212 and the LIS 202 may be in any format convenient suitable to switch 106, with the LIS 202 transmitting messages to the LIDF 104 in a format suitable for that device.

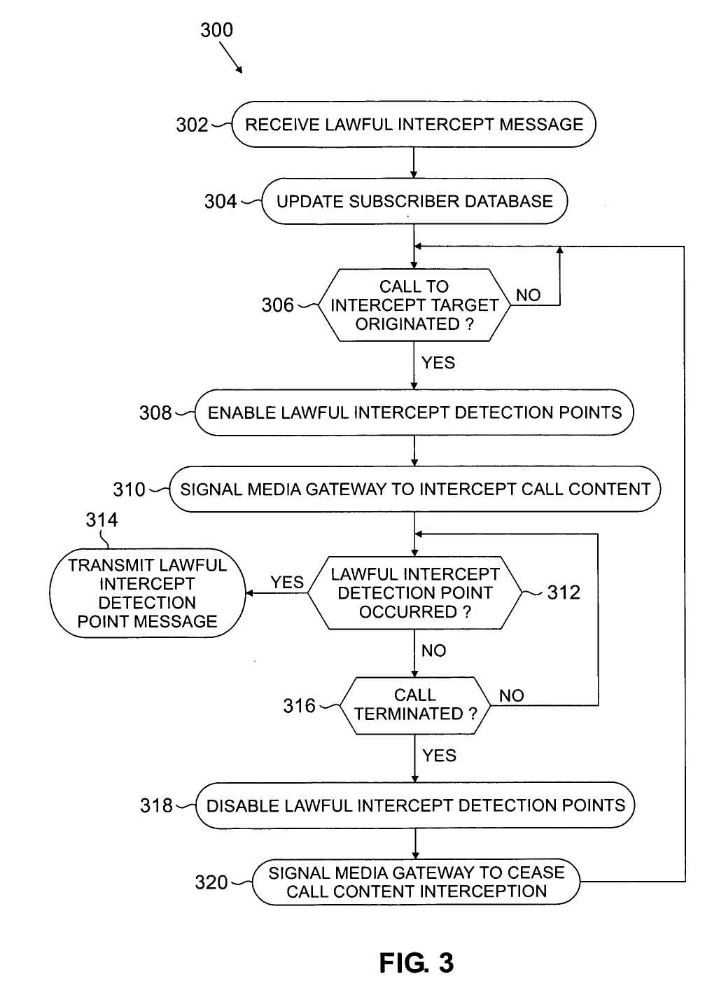

FIG. 3 is a flow chart of call data and call content interception in a telecommunications switch according to one embodiment of the present disclosure. At step 302, the lawful intercept server 202 receives a lawful intercept message from the lawful intercept delivery function 104. Included in the message is an indicator identifying a lawful intercept target device 110. At step 304, the LIS 202 causes subscriber database 208 to be updated to reflect the intercept status of the identified target device 110. The switch 106 then proceeds to step 306, wherein it awaits an origination of a call associated with the identified target device 110.

When the origination of a call associated with the target device 110 is detected in step 306, the CCF 204, in accordance with the intercept status of the target device 110 in the subscriber database 208, causes the service control point 210 and/or the access control function 212 to enable lawful intercept detection points in step 308. If authorized, the CCF 204 also signals the media gateway 108 in step 310 to begin intercepting call content and forwarding the intercepted content to the LIDF 104. As LIDPs are detected at step 312, the LIS 202 is notified and transmits associated lawful intercept detection point messages to the LIDF 104, at step 314. At step 316, the switch 106 determines whether the call to the intercept target has been terminated and, if not, cycles back to step 312 to continue monitoring for LIDPs.

When the call to the intercept target is found in step 316 to have been terminated, the CCF 204 causes the SCP 210 and/or the ACF 212 to disable the LIDPs in step 318 and, if appropriate, signals the media gateway 108 to cease intercepting and forwarding call content in step 320. The switch 106 then returns to step 306 to await the origination of another call associated with the intercept target device 110.

At step 306, the switch 106 may also receive a message from the LIDF 104 modifying the type of surveillance authorized or deleting the intercept on the intercept target identified in the lawful intercept message received in step 302. In response to such a message, the switch will update the subscriber database 208 to reflect the change in intercept status of the target device, or to reflect that the target device is no longer subject to interception of call data and/or call content. If the intercept has been deleted on the target, the switch will cease executing step 306 and begin waiting for a new lawful intercept message from the LIDF 104.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A switch for use in a telecommunications network, the switch comprising:
a call control function; and
a lawful intercept server, wherein the lawful intercept server is capable of receiving a lawful intercept message identifying a target device and, in response to a subsequent origination of a call associated with the target device, the call control function is capable of enabling a lawful intercept detection point associated with the call, and wherein, in response to an occurrence of the enabled lawful intercept detection point, the lawful intercept server is capable of transmitting a message indicating the occurrence of the lawful intercept detection point.

2. The switch as set forth in claim 1, wherein the switch comprises an access control function and the lawful intercept detection point is one of a CCOpen message, a CCClose message, and a Network Signal message.

3. The switch as set forth in claim 1, wherein the switch is associated with a service control point and the lawful intercept detection point is one of an Answer message, an origination message, a Release message, and a Termination Attempt message.

4. The switch as set forth in claim 1, wherein the switch comprises an access control function and is associated with a service control point and, upon a subsequent origination of a call associated with the target device, the call control function is capable of causing both the access control function and the service control point to enable lawful intercept detection points associated with the call.

5. The switch as set forth in claim 4, wherein the lawful intercept detection point is one of a CCOpen message, a CCClose message, a Network Signal message, an Answer message, an origination message, a Release message, and a Termination Attempt message.

6. The switch as set forth in claim 4, wherein the service control point is co-located with the switch.

7. The switch as set forth in claim 1, wherein the call control function is associated with a subscriber database, and wherein, in response to the lawful intercept message identifying the target device, the lawful intercept server is capable of causing the call control function to update the subscriber database to reflect the intercept status of the target device, and wherein, in response to the subsequent origination of the call associated with the target device, the call control function enables the lawful intercept detection point in accordance with the intercept status of the target device in the subscriber database.

8. The switch as set forth in claim 1, wherein the target device is one of a telephone, a fax machine, a pager, and a computing device using one of an ISUP, a SIP, an H.323, and a POTS protocol.

9. The switch as set forth in claim 1, wherein the lawful intercept message is received from a lawful intercept delivery function, and the message indicating the occurrence of the lawful intercept detection point is transmitted to the lawful intercept delivery function.

10. The switch as set forth in claim 9, wherein the switch, upon the subsequent origination of the call associated with the target device, causes a media gateway to transmit a call content of the call to the lawful intercept delivery function.

11. For use in a telecommunications network, a method of lawful intercept detection of call data and call content, the method comprising:
receiving a lawful intercept message identifying a target device;
upon a subsequent origination of a call associated with the target device, enabling a lawful intercept detection point associated with the call;
upon the occurrence of an enabled lawful intercept detection point, transmitting a message indicating the occurrence of the lawful intercept detection point.

12. The method as set forth in claim 11, wherein the lawful intercept detection point is one of a CCOpen message, a CCClose message, a Network Signal message, an Answer message, an Origination message, a Release message, and a Termination Attempt message.

13. The method as set forth in claim 11, wherein the target device is one of a telephone, a fax machine, a pager, and a computing device using one of an ISUP, a SIP, an H.323, and a POTS protocol.

14. The method as set forth in claim 11, wherein the lawful intercept message is received from a lawful intercept delivery function, and the message indicating the occurrence of the lawful intercept detection point is transmitted to the lawful intercept delivery function.

15. The method as set forth in claim 14, wherein the method further comprises:
upon the origination of the call associated with the target device, causing a media gateway to transmit a call content of the call to the lawful intercept delivery function.

16. The method as set forth in claim 11, further comprising the step of updating a subscriber database according to the lawful intercept message to reflect an intercept status of the target device,
wherein, upon the subsequent origination of the call associated with the target device, the lawful intercept detection point is enabled in accordance with the intercept status of the target device in the subscriber database.

17. Logic for use in a switch of a telecommunications network, wherein the logic is operable to
receive a lawful intercept message identifying a target device;
upon a subsequent origination of a call associated with the target device, enable a lawful intercept detection point associated with the call;
upon the occurrence of an enabled lawful intercept detection point, transmit a signal indicating the occurrence of the lawful intercept detection point.

18. The logic as set forth in claim 17, wherein the lawful intercept detection point is one of a CCOpen message, a CCClose message, a Network Signal message, an Answer message, an Origination message, a Release message, and a Termination Attempt message.

19. The logic as set forth in claim 17, wherein the target device is one of a telephone, a fax machine, a pager, and a computing device using one of an ISUP, a SIP, an H.323, and a POTS protocol.

20. The logic as set forth in claim 17, wherein
the lawful intercept message is received from a lawful intercept delivery function, and
the message indicating the occurrence of the lawful intercept detection point is transmitted to the lawful intercept delivery function.

21. The logic as set forth in claim 20, wherein the logic further operable to:
upon the origination of the call associated with the target device, cause a media gateway to transmit a call content of the call to the lawful intercept delivery function.

22. The logic as set forth in claim 17, wherein the logic further operable to update a subscriber database according to the lawful intercept message to reflect an intercept status of the target device, and wherein, upon the subsequent origination of the call associated with the target device, the lawful intercept detection point is enabled in accordance with the intercept status of the target device in the subscriber database.
